(19) United States
(12) Patent Application Publication
(10) Pub. No.: US 2011/0298919 A1
(43) Pub. Date: Dec. 8, 2011

(54) Apparatus Using an Accelerometer to Determine a Point of View for Capturing Photographic Images

(76) Inventor: Chad L. Maglaque, Seattle, WA (US)

(21) Appl. No.: 13/083,573

(22) Filed: Apr. 10, 2011

Related U.S. Application Data
(60) Provisional application No. 61/350,481, filed on Jun. 2, 2010.

(51) Int. Cl. H04N 7/18

(52) U.S. Cl. 348/143; 348/E07.085

(57) ABSTRACT

Methods and apparatuses for operating an electronic device based on an accelerometer to capture photographic images with a camera integrated into the display screen are described.

### CROSS REFERENCE TO RELATED APPLICATIONS

This application claims priority from the U.S. Provisional Patent Application Ser. No. 61/350,481 filed Jun. 2, 2010, the disclosure of which is attached in Appendix A hereto and incorporated herein by reference.

### BACKGROUND

The present invention relates generally to an electronic device. More particularly, this invention relates to operating an electronic device using an accelerometer of the electronic device for capturing photographic images with a camera integrated into the display screen of the electronic device.

Many personal computers, cell phones, personal digital assistants, and other electronic devices include built-in video cameras. These cameras enable users to take pictures, capture video, and participate in videoconferences.

One problem with traditional built-in cameras stems from the way that the cameras are mounted to (or within) the electronic device. Because the cameras are attached to a mounting point that is adjacent to the user's video display, the user cannot simultaneously look into the camera and view his or her display. Hence, it is difficult for the user to maintain eye contact during a videoconference with another person, because looking at the other person in the display means looking away from the camera. Users find themselves constantly looking back and forth between the display screen and the camera, which can be distracting and make the conversation seem awkward and unnatural. For the same reason, when attempting to take a self-portrait, a user cannot see what the photo will actually look like because glancing at the display means looking away from the camera. When looking at their display, users see an image of themselves looking away at an angle instead of looking directly into the camera. Thus, users that want a head-on portrait must look away from the display and into the camera, shooting blindly without any visual feedback from the display to guide them.

Some image-capturing mechanisms attempt to solve this problem by integrating the image-capturing mechanism directly into the display screen of the electronic device, for example in U.S. Patent Application 2009/0009628.

While an integrated display camera is a much needed improvement over existing image-capturing mechanisms, also needed is the ability to monitor the orientation of an electronic device to ensure that the integrated display camera captures a user facing the display from the best possible viewpoint and is able to maintain this view when the orientation of the electronic device changes.

Accelerometers are devices widely used for applications as diverse as vibration monitoring, appliance control, joysticks, industrial process control, space launches, satellite control, and many others. For example, an accelerometer has been used in a vehicle as sensor to detect a variety of operating conditions while the vehicle is moving.

As computers have been getting more popular, an accelerometer has been used in a computer to sense a sudden move, such as a free fall, of a computer. A typical application of an accelerometer in a computer is to protect a read/write head of a hard drive. However, there has been a lack of applications that an accelerometer is used in conjunction with software executable within a computer.

### SUMMARY

Methods and apparatuses for operating an electronic device based on an accelerometer are described. According to one embodiment of the invention, an accelerometer attached to an electronic device detects a movement of the electronic device. In response, a machine executable code is executed to perform a predetermined user configurable operation.

According to one embodiment of the invention, an accelerometer of an electronic device may constantly or periodically monitor the movement of the electronic device. As a result, an orientation of the electronic device prior to the movement and after the movement may be determined based on the movement data provided by the accelerometer attached to the electronic device.

According to another embodiment of the invention, an accelerometer may be used to detect a movement of an electronic device and an orientation of the electronic device may be determined based on the movement data provided by the accelerometer. Thereafter, the frame of view of one or more one or more image capturing image-capturing mechanisms integrated into the display screen of the electronic device may be based on the determined orientation after the movement.

### BRIEF DESCRIPTION OF THE FIGURES

Various embodiments of the present invention are described herein by way of example in conjunction with the following figures, wherein:

FIG. 1 is a block diagram illustrating an exemplary architecture of an electronic device according to one embodiment of the invention.

FIG. 2 is a flow diagram illustrating an exemplary process for operating an electronic device in response to an event generated by an accelerometer, according to one embodiment of the invention.

FIG. 3A is a diagram illustrating exemplary movements of an electronic device that may be used to change the frame of view of one or more integrated display cameras, according to one embodiment of the invention.

FIG. 3B is a diagram illustrating an exemplary frame of view of one or more integrated display cameras as the frame of view is shifted within the field of view, according to one embodiment of the invention.

FIG. 3C is a diagram illustrating an exemplary frame of view of one or more integrated display cameras as the field of view is shifted, according to one embodiment of the invention.

FIG. 3D is a diagram illustrating the direction of the field of view of one or more integrated display cameras, and an expected point of view, according to one embodiment of the invention.

FIG. 10 is a block diagram illustrating an exemplary electronic device having an accelerometer according to one embodiment of the invention.

FIG. 11 is a block diagram of a digital processing system which may be used with one embodiment of the invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In general, terms used herein should be read to have their ordinary and common meanings as understood by one of ordinary skill in the art in view of the descriptions provided herein.

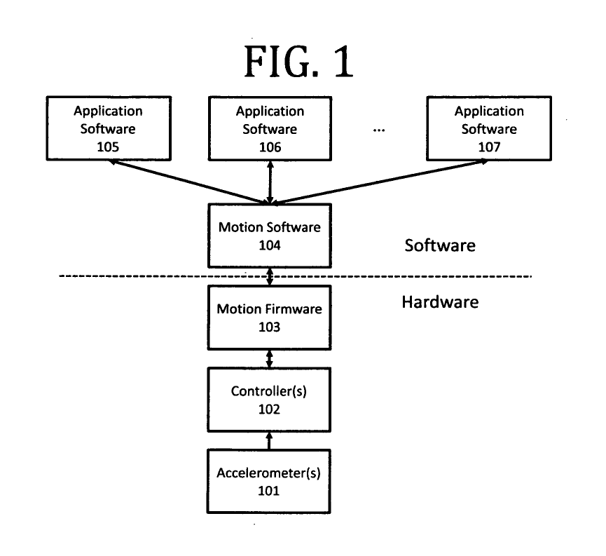

FIG. 1 is a block diagram illustrating an exemplary architecture of an electronic device according to one embodiment of the invention. In one embodiment, the exemplary system 100 includes, but is not limited to, a processor, a memory coupled to the processor, the memory having instructions stored therein, and an accelerometer coupled to the processor and the memory to detect movement of the electronic device, where the processor executes instructions from the memory to perform one or more predetermined user configurable actions in response to the detection of the movement of the electronic device. In an alternative embodiment, the exemplary system 100 further includes a controller coupled to the accelerometer to determine a direction of the movement based on movement data provided by the accelerometer and to compare the determined direction of the movement with a predetermined direction to determine whether the determined direction relatively matches the predetermined direction in order to execute the instructions.

Referring to FIG. 1, according to one embodiment, exemplary system 100 includes one or more accelerometers 101, one or more controllers 102 coupled to the accelerometers 101, a motion related firmware 103, motion software component 104, and one or more application software 105-107. The accelerometer 101 may be attached to the electronic device, such as, for example, a motherboard of the electronic device. Alternatively, the accelerometer 101 may be integrated with another component of the electronic device. For example, the accelerometer 101 may be integrated with a chipset of the electronic device. Further still, the accelerometer 101 may include or be integrated with a gyroscope.

According to one embodiment, the accelerometer 101 is able to detect a movement including an acceleration and/or de-acceleration of the electronic device. The accelerometer 101 may generate movement data for multiple dimensions, which may be used to determine a moving direction of the electronic device. For example, the accelerometer 101 may generate X, Y, and Z axis acceleration and movement information when the accelerometer 101 detects that the electronic device is moved. In one embodiment, the accelerometer 101 may be implemented as those described in U.S. Pat. No. 6,520,013. Alternatively, the accelerometer 101 may be implemented using a variety of accelerometers commercially available. For example, the accelerometer 101 may be a KGF01 accelerometer from Kionix or an ADXL311 accelerometer from Analog Devices.

In addition, the exemplary system 100 includes one or more controllers 102 coupled to the accelerometer(s) 101. The controller 102 may be used to calculate a moving direction, also referred to as moving vector, of the electronic device. The moving vector may be determined according to one or more predetermined formulas based on the movement data (e.g., X, Y, and Z axis moving information) provided by the accelerometer 101. Certain embodiments of calculations of a moving vector will be described in details further below.

According to one embodiment, the controller 102 is responsible for monitoring one or more outputs of the accelerometer 101 and communicating with other components, such as, for example, a chipset (e.g., a memory controller or a north bridge) and/or a microprocessor (e.g., a CPU), of the electronic device. The controller 102 may be implemented using a variety of microcontrollers commercially available. For example, controller 102 may be a PIC 16F818 microcontroller from Microchip. Controller 102 may be integrated with the accelerometer 101. Alternatively, controller 102 may be integrated with other components, such as, for example, a chipset or a microprocessor, of the electronic device.

In one embodiment, the controller 102 may communicate with other components via a bus, such as, for example, an I2C (inter-IC) bus, and an interrupt line. In response to the movement data, the controller 102 generates an interrupt, for example, a hardware interrupt, a software interrupt, or a combination of both, via an interrupt line to other components, such as, firmware 103, to notify them of such a movement. In addition, the controller 102 may further calculate a moving vector based on the movement data provided by the accelerometer 101. Further detailed information concerning the communications between the controller 102 and other components of the electronic device will be described further below.

Referring back to FIG. 1, motion firmware 103 includes one or more pieces of machine executable code, which may be embedded within one or more hardware components, such as, for example, controller 102 or a chipset (e.g., a part of BIOS, also referred to as basic input/output system), of the electronic device. In one embodiment, motion firmware 103 may be stored in a read-only memory (ROM) (e.g., a flash memory) of controller 102. However, the machine executable code of motion firmware 103 may be upgraded by uploading a newer version into the memory, for example, using a flash utility. The firmware 103 may be responsible for detecting any events that are generated in response to the movement detection. According to one embodiment, the firmware 103 provides a primary communications mechanism between controller 102 and other components, such as, for example, an operating system (OS), of the electronic device.

Motion software 104 may be responsible for communicating between the motion firmware 103 and the rest of software components, such as application software components 105-107, as well as the operating system. In one embodiment, the motion software 104 may be implemented as a part of an operating system, such as, for example, a kernel component or a device driver, etc. The operating system may be implemented using a variety of operating systems commercially available. For example, the operating system may be a Mac OS from Apple Computer. Alternatively, the operating system may be a Windows operating system from Microsoft. Other operating systems, such as, for example, a Unix, a Linux, an embedded operating system (e.g., a Palm OS), or a real-time operating system, may also be implemented.

According to one embodiment, in response to the motion detection event, which may be notified by the motion firmware 103, the motion software component 104 may communicate the event to one or more application software 105-107. In response to the detection, the application software 105-107 may perform certain operations. The applications 105-107 may be a variety of different applications, such as, image-capture software, etc. Certain embodiments of the operations performed by the applications 105-107 will be described in details further below.

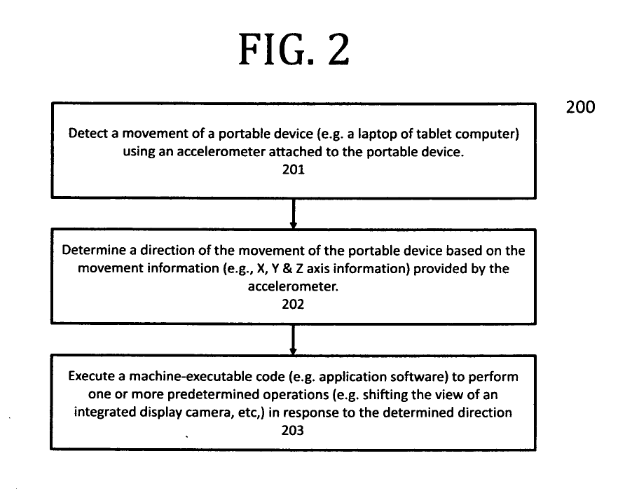

FIG. 2 is a flow diagram illustrating an exemplary process for operating an electronic device in response to an event generated by an accelerometer, according to one embodiment of the invention. Exemplary process 200 may be performed by a processing logic that may comprise hardware (circuitry, dedicated logic, etc.), software (such as is run on a dedicated machine), or a combination of both. In one embodiment, exemplary process 200 includes, but is not limited to, detecting movement of an electronic device using an accelerometer attached to the electronic device, and executing machine-executable code to perform one or more predetermined user configurable actions in response to the detection of the movement of the electronic device.

Referring to FIG. 2, at block 201, a movement of an electronic device, such as, for example, a laptop computer or a tablet computer, is detected using an accelerometer (e.g., accelerometer 101 of FIG. 1) attached to the electronic device. In one embodiment, in response to the detection, the accelerometer may generate movement data for multiple dimensions (e.g., X, Y, and Z axes). In response to the detection, at block 202, a direction of the movement is determined based on the movement data provided by the accelerometer. In one embodiment, the direction of the movement is determined by a controller (e.g., controller 102 of FIG. 1). In response to the determined direction, at block 203, one or more machine executable code (e.g., application software) may be executed to perform one or more predetermined user configurable actions, such as, for example, activating one or more integrated display cameras integrated into the display screen of the electronic device, etc. Other operations may also be performed.

### Determining Orientation Based on an Accelerometer

According to one embodiment of the invention, an accelerometer of an electronic device may constantly or periodically monitor the movement of the electronic device. As a result, an orientation of the electronic device prior to the movement and after the movement may be determined based on the movement data provided by the accelerometer attached to the electronic device.

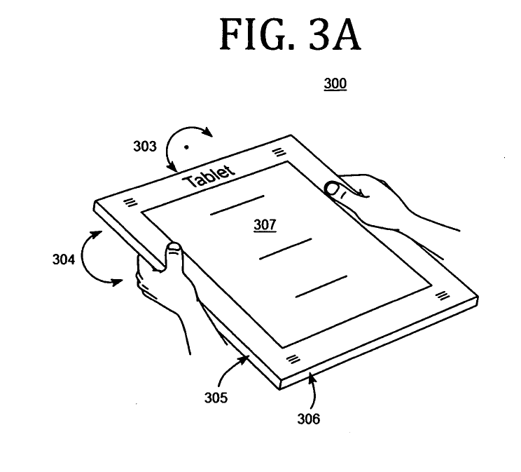

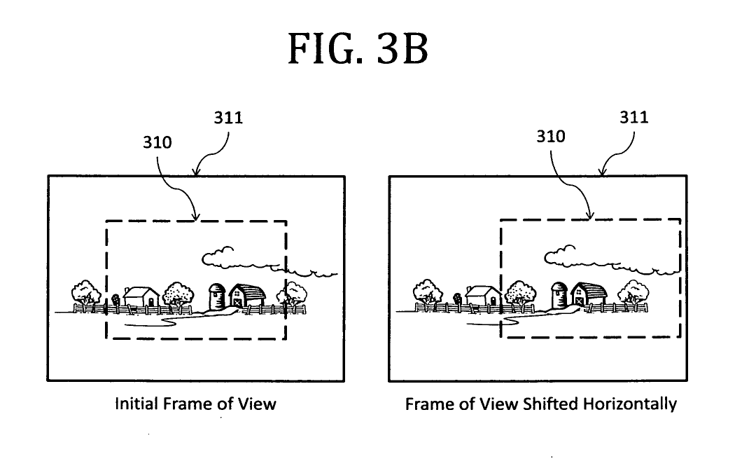

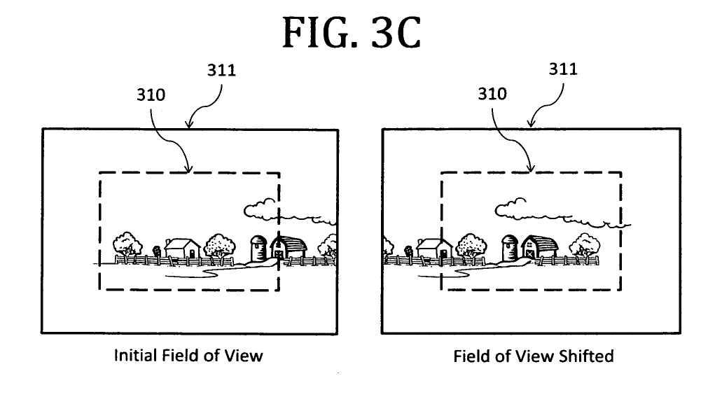

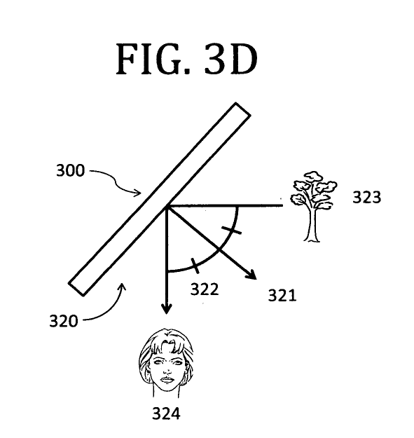

FIG. 3A is a diagram illustrating exemplary movements of an electronic device that may be used to change the frame of view of one or more integrated display cameras, according to one embodiment of the invention. In this embodiment, and throughout the application, a computer tablet device is used as an example of an electronic device. But it is not so limited. It will be appreciated that other electronic devices, such as, a laptop computer, a tablet computer, a personal digital assistant (PDA), a personal communicator (e.g., a blackberry from Research In Motion), a cellular phone, or a multimedia player (e.g., an MP3 player), etc., may also be utilized. Further, in this embodiment, and throughout the application, integrated display cameras are used as an example of an image-capturing device. But it is not so limited. It will be appreciated that integrated display cameras may be disposed on different locations of the electronic device.

Referring to FIG. 3A, one or more integrated display cameras are integrated into a display screen 307 of the electronic device 300. When the electronic device 300 is moved in certain directions, an accelerometer (e.g., accelerometer 101 of FIG. 1) attached to the electronic device 300 may detect such a movement. In response to the detection, the accelerometer may notify, via the associated controller, firmware, and/or OS, other components such as application software, particularly the one controlling images being captured by one or more integrated display cameras.

In a particular embodiment, the accelerometer may notify a controller (e.g., controller 102 of FIG. 1) including providing the movement data (e.g., X, Y, and Z axes). The controller and/or the firmware may calculate the moving vector of the movement based on the movement data provided by the accelerometer. Thereafter, the controller may signal other components, such as motion software component (e.g., motion software 104) and/or the operating system. The motion software and/or the operating system may compare the moving vector with a predetermined direction to determine whether the moving vector relatively matches the predetermined direction, for example, based on a predetermined threshold.

In one embodiment, the predetermined direction and the threshold (e.g., sensitivity) associated with the predetermined direction may be user configurable via a user interface. Such a sensitivity may be configured based on different profiles associated with the electronic device at a given time and place. For example, the sensitivity of the electronic device may be different when it is at a home/office versus on a moving platform (e.g., a car, a train, a ship or an airplane, etc.) In a further embodiment, the electronic device may include a mechanism to intelligently filter out some “noisy” movement background.

If the moving vector relatively matches the predetermined direction, the associated application software may be notified. In response, the associated application software may perform certain operations, including shifting the frame of view of one or more integrated display cameras based on the determined orientation of the electronic device. In one embodiment, the frame of view of one or more integrated display cameras can be shifted, either by shifting the frame of view 310 within the field of view 311 of one or more integrated display cameras (as illustrated in FIG. 3B), or by shifting the field of view 310 of one or more integrated display cameras itself (as illustrated in FIG. 3C). Shifting the frame of view of one or more integrated display cameras based on the determined orientation of the electronic device ensures a more accurate view of the subject facing the display of the electronic device. For example, as illustrated in FIG. 3D a viewer 324 may turn the electronic device 300 to one side, for example, according to a movement 320, changing the direction of the field of view of one or more integrated display cameras from the viewer 324 to a point in space 321. However, shifting the view of the integrated display camera by an amount less than or equal to angle 322 ensures a more optically accurate view of the subject 323 expected by a viewer 324. Other moving directions, such as those or a combination of those shown in FIG. 3A, may also be utilized.

Referring to FIG. 3A, the moving directions may include may include a rotation of the electronic device with respect to an axis parallel with an edge (e.g., edges 305 and 306) of the electronic device, as shown as directions 303 and 304. Furthermore, the moving directions of the electronic device may be a combination of the above directions. For example, the movement may be multiple dimension spin with respect to a corner of the electronic device 300. Other types of the movements may be utilized.

According to another embodiment, the techniques described above may be used in an augmented reality environment. In one embodiment, it allows a user to use the accelerometer equipped electronic device as a digital mirror to view themselves the same way they would in an optical mirror. For example, a user holding the electronic device 300 can tilt the electronic device 300 side to side, up or down to view themselves from different angles (as illustrated in FIG. 3D). According to another embodiment, the orientation of computer generated 3D objects generated by the electronic device 300 can be set to match changes in the orientation of the electronic device 300 relative to the user holding the electronic device, allowing the user to view composite images of themselves along with the computer generated 3D objects in real-world settings, for example, viewing themselves wearing virtual fashions (e.g., clothing, glasses, cosmetics, etc.) personal avatars, etc.

### Exemplary Electronic Device Having an Accelerometer

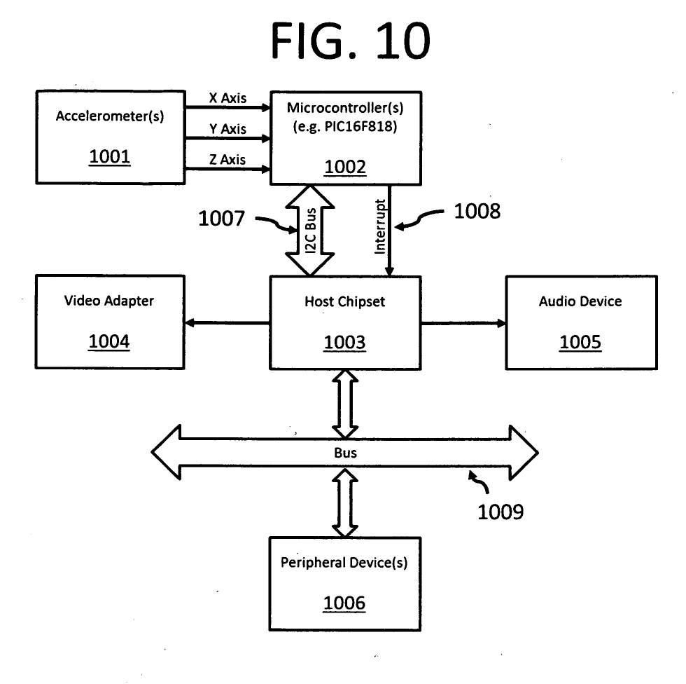

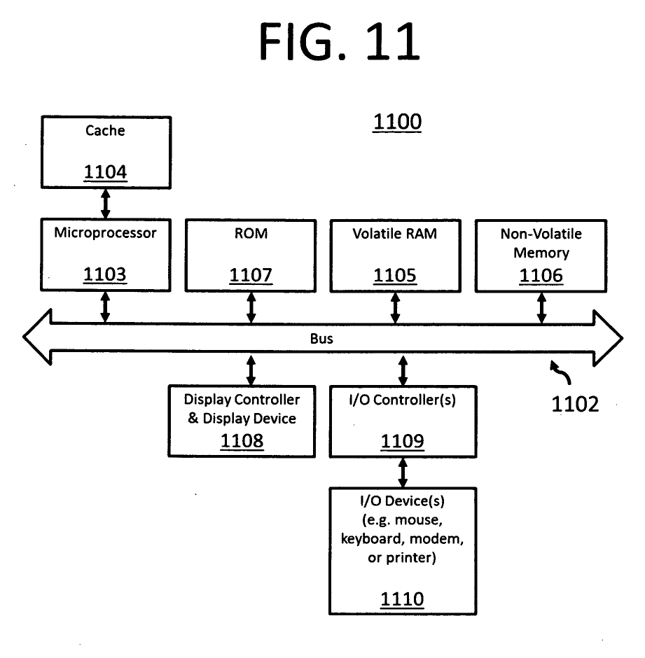

FIG. 10 is a block diagram illustrating an exemplary electronic device having an accelerometer according to one embodiment of the invention. For example, exemplary system 1000 may represent at least a portion (e.g., a subsystem) of the exemplary system 100 shown in FIG. 1 or exemplary system 1100 of FIG. 11. Referring to FIG. 10, exemplary system 1000 includes one or more accelerometers 1001, one or more microcontrollers 1002, a host chipset 1003 that may be coupled to a video adapter 1004 and an audio device 1005, and one or more peripheral devices 1006.

In one embodiment, the accelerometer 1001 is a 3-axis accelerometer, which may provide acceleration data on X, Y, and Z axes. The accelerometer is an electromechanical micro machine encapsulated in a chip package. It presents three analog outputs (e.g., X, Y, and Z axes) whose values are directly proportional to the acceleration being measured along corresponding axes in 3-space. In one embodiment, the accelerometer 1001 may be a KGF01 accelerometer from Kionix or an ADXL311 accelerometer from Analog Devices.

The microcontroller 1002 is responsible for monitoring the analog outputs of the accelerometer 1001 and communicating with the host via the chipset 1003. In one embodiment, the microcontroller 1002 is coupled to the host chipset 1003 via an I2C bus 1007 and an interrupt line 1008. Alternatively, the microcontroller 1002 may be integrated with the host chipset 1003. In one embodiment, the microcontroller 1002 may be a PCI 16F818 microcontroller from Microchip.

According to one embodiment, when the accelerometer 1001 detects that the electronic device is moving, the microcontroller 1002 receives the 3-axis acceleration information from the accelerometer 1001 and notifies the host via the interrupt line 1008. In response, the movement data may be read out from the microcontroller 1002 via the I2C bus 1007. In one embodiment, the microcontroller 1002 may determine a moving direction based on the 3-axis acceleration information received from the accelerometer 1001. Alternatively, the host chipset may perform such operations. In one embodiment, the magnitude of the resultant acceleration vector of all three axes may be determined according to the following formula:

Mag(Accelerationᵣₑₛᵤₗₜₐₙₜ)=Sqrt(X_{accel}²+Y_{accel}²+Z_{accel}²)

In response to the determined magnitude of the acceleration vector, one or more software components (e.g., application software, firmware, and operating system, etc.) executed within the exemplary system 1000 may perform certain operations, for example, those described above throughout the present application. For example, an orientation of a displayed image may be adjusted via the video adapter 1004 and the sound effects may be adjusted via audio device 1005, etc. Furthermore, one or more peripheral devices 1006, such as, for example, integrated display cameras, may be configured accordingly. Other configurations may exist.

### Exemplary Data Processing System

FIG. 11 is a block diagram of a digital processing system which may be used with one embodiment of the invention. For example, the system 1100 shown in FIG. 11 may be used as the exemplary systems shown in FIGS. 1 and 10.

Note, that while FIG. 11 illustrates various components of a computer system, it is not intended to represent any particular architecture or manner of interconnecting the components, as such details are not germane to the present invention. It will also be appreciated that network computers, handheld computers, cell phones, multimedia players, and other data processing systems which have fewer components or perhaps more components may also be used with the present invention. The computer system of FIG. 11 may, for example, be an Apple Macintosh computer or an IBM compatible PC.

As shown in FIG. 11, the computer system 1100, which is a form of a data processing system, includes a bus 1102 which is coupled to a microprocessor 1103 and a ROM 1107, a volatile RAM 1105, and a non-volatile memory 1106. The microprocessor 1103, which may be, for example, a PowerPC G4 or PowerPC G5 microprocessor from Motorola, Inc. or IBM, is coupled to cache memory 1104 as shown in the example of FIG. 11. The bus 1102 interconnects these various components together and also interconnects these components 1103, 1107, 1105, and 1106 to a display controller and display device 1108, as well as to input/output (I/O) devices 1110, which may be mice, keyboards, modems, network interfaces, printers, and other devices which are well-known in the art. Typically, the input/output devices 1110 are coupled to the system through input/output controllers 1109. The volatile RAM 1105 is typically implemented as dynamic RAM (DRAM) which requires power continuously in order to refresh or maintain the data in the memory. The non-volatile memory 1106 is typically a magnetic hard drive, a magnetic optical drive, an optical drive, or a DVD RAM or other type of memory system which maintains data even after power is removed from the system. Typically, the non-volatile memory will also be a random access memory, although this is not required. While FIG. 11 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1102 may include one or more buses connected to each other through various bridges, controllers, and/or adapters, as is well-known in the art. In one embodiment, the I/O controller 1109 includes a USB (Universal Serial Bus) adapter for controlling USB peripherals. Alternatively, I/O controller 1109 may include an IEEE-1394 adapter, also known as FireWire adapter, for controlling FireWire devices. Other components may be included.

Thus, methods and apparatuses for operating an electronic device using an accelerometer have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An electronic device, comprising: a processor; a display; a memory coupled to the processor, the memory having instructions stored therein; and an accelerometer coupled to the processor and the memory to detect movement of the electronic device, wherein the processor executes instructions from the memory to perform one or more predetermined user configurable actions in response to the detection of the movement of the electronic device, including detecting whether the movement of the electronic device is in accordance with a direction associated with the direction of the transition from the viewpoint of the user, and performing a predetermined operation if the movement is not detected in accordance with a direction associated with the direction of the transition.

2. The electronic device of claim 1, further comprising a controller coupled to the accelerometer and the processor to determine a direction of the movement based on movement data provided by the accelerometer, and compare the determined direction of the movement with a predetermined direction to determine whether the determined direction relatively matches the predetermined direction in order to execute the instructions.

3. The electronic device of claim 2, wherein the processor is configured to determine an orientation of the electronic device after the movement based on movement data collected by the accelerometer, wherein the one or more predetermined user configurable actions are performed based on the determined orientation.

4. The electronic device of claim 3, wherein the processor is configured to orient at least one camera of the electronic device to match the expected point of view of the camera subject given the determined orientation.

5. The electronic device of claim 3, wherein the processor is configured to determine whether the portable device is held by a user after the movement based on the movement data provided by the accelerometer.

6. The electronic device of claim 1, wherein the electronic device is one of a laptop computer, a tablet computer, a PDA (personal digital assistant), a cellular phone, a personal communicator, and a multimedia player.

7. An apparatus, comprising: means for detecting movement of an electronic device using an accelerometer attached to the electronic device; and means for executing machine-executable code to perform one or more predetermined user configurable actions in response to the detection of the movement of the electronic device, including means for detecting whether the movement of the electronic device is in accordance with a direction associated with the direction of the transition from the viewpoint of the user, and means for performing a predetermined operation if the movement is not detected in accordance with a direction associated with the direction of the transition.

8. The apparatus of claim 7, further comprising: means for determining a direction of the movement based on movement data provided by the accelerometer; and means for comparing the determined direction of the movement with a predetermined direction to determine whether the determined direction relatively matches the predetermined direction in order to execute the machine-executable code.

9. The apparatus of claim 8, further comprising means for determining an orientation of the electronic device after the movement based on movement data collected by the accelerometer, wherein the one or more predetermined user configurable actions are performed based on the determined orientation.

10. The apparatus of claim 8, further comprising means for orienting at least one camera of the electronic device to match the expected point of view of the camera subject given the determined orientation.

11. The apparatus claim 8, further comprising means for determining whether the portable device is held by a user after the movement based on the movement data provided by the accelerometer.

12. The apparatus of claim 7, wherein the electronic device is one of a laptop computer, a tablet computer, a PDA (personal digital assistant), a cellular phone, a personal communicator, and a multimedia player.

13. A method, comprising: detecting movement of the electronic device using an accelerometer attached to the electronic device; and executing machine-executable code to perform one or more predetermined user configurable actions in response to the detection of the movement of the electronic device, including detecting whether the movement of the electronic device is in accordance with a direction associated with the direction of the transition from the viewpoint of the user, and performing a predetermined operation if the movement is not detected in accordance with a direction associated with the direction of the transition.

14. The method of claim 13, further comprising: determining a direction of the movement based on movement data provided by the accelerometer; and comparing the determined direction of the movement with a predetermined direction to determine whether the determined direction relatively matches the predetermined direction in order to execute the machine-executable code.

15. The method of claim 14, further comprising determining an orientation of the electronic device after the movement based on movement data collected by the accelerometer, wherein the one or more predetermined user configurable actions are performed based on the determined orientation.

16. The method of claim 15, further comprising orienting at least one camera of the electronic device to match the expected point of view of the camera subject given the determined orientation.

17. The method of claim 15, further comprising determining whether the portable device is held by a user after the movement based on the movement data provided by the accelerometer.

18. The method of claim 13, wherein the electronic device is one of a laptop computer, a tablet computer, a PDA (personal digital assistant), a cellular phone, a personal communicator, and a multimedia player.
